(19) United States
(12) Patent Application Publication
(10) Pub. No.: US 2026/0194940 A1
(43) Pub. Date: Jul. 9, 2026

(54) PLUGGABLE EXPANSION MODULE AND PLUGGABLE EXPANSION DEVICE THEREOF

(71) Applicant: WNC Corporation, Hsinchu (TW)

(72) Inventors: Po-Chien CHEN, Hsinchu (TW); Ming-Chan LEE, Hsinchu (TW); Po-Yu WANG, Hsinchu (TW); Yu-Shuo WU, Hsinchu (TW)

(21) Appl. No.: 19/349,235

(22) Filed: Oct. 3, 2025

(30) Foreign Application Priority Data
Jan. 3, 2025 (TW) 114100276

(51) Int. Cl. G06F 1/185; G06F 1/186; H01R 31/06

(52) U.S. Cl. CPC G06F 1/185; G06F 1/186; H01R 31/06

(57) ABSTRACT

A pluggable expansion device is suitable for connecting an electronic device and an extension expansion device. The pluggable expansion device includes a device housing and a circuit board. The device housing includes a first connection interface and a second connection interface. The circuit board is disposed within the device housing, wherein the circuit board includes a first port and a second port, the first port corresponds to the first connection interface and is configured to connect to the electronic device. The second port corresponds to the second connection interface and is configured to connect to the extension expansion device.

### CROSS REFERENCE TO RELATED APPLICATIONS

This application claims the benefit of priority to Taiwan Patent Application No. 114100276, filed on January 3, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### BACKGROUND OF THE INVENTION

### Field of the Invention

The present disclosure relates to an expansion device, particularly to a pluggable expansion device.

### Description of the Related Art

Conventionally known pluggable expansion devices are used for connecting electronic devices (such as network switches, routers, etc.) and providing data communication functions. Conventional pluggable expansion devices are relatively inconvenient to grip, making them difficult for users to operate. The gold fingers are covered by the housing, making it difficult to check whether the gold fingers have oxidized or are damaged. Additionally, conventional pluggable expansion devices are time-consuming to assemble and pose risks of collision damage.

### BRIEF SUMMARY OF THE INVENTION

The embodiment of the present disclosure is provided to solve the problems of conventional technology by offering a pluggable expansion device suitable for connecting an electronic device and an extension expansion device. The pluggable expansion device includes a device housing and a circuit board. The device housing includes a first connection interface and a second connection interface. The circuit board is disposed within the device housing, wherein the circuit board includes a first port and a second port, the first port corresponds to the first connection interface and is configured to connect to the electronic device, and the second port corresponds to the second connection interface and is configured to connect to the extension expansion device.

In one embodiment, the device housing includes a concave-convex structure formed within the second connection interface, which is suitable for contacting the extension expansion device.

In one embodiment, the pluggable expansion device further includes a fastener, wherein the device housing is formed with a through hole. When the extension expansion device is connected to the second port, the fastener passes through the through hole and abuts the extension expansion device.

In one embodiment, the through hole is formed in the concave-convex structure.

In one embodiment, the device housing includes a first housing part and a second housing part, the first housing part is combined with the second housing part, and the circuit board is disposed between the first housing part and the second housing part.

In one embodiment, the first housing part includes a first fitting structure, and the second housing part includes a second fitting structure, and the first fitting structure fits with the second fitting structure.

In one embodiment, the pluggable expansion device further includes a sheet metal fastener, wherein the sheet metal fastener connects the first housing part and the second housing part.

In one embodiment, the first housing part includes a guiding slope corresponding to the first connection interface.

In one embodiment, a window is formed on the guiding slope, corresponding to the first port.

In one embodiment, the first housing part includes a separation bump formed on at least one side edge of the first housing part.

In one embodiment, the first housing part includes a plurality of lateral locking holes, and each lateral locking hole extending in a direction parallel to the width direction of the pluggable expansion device.

In one embodiment, the first housing part includes an anti-slip structure formed on the outer surface of the first housing part.

In one embodiment, the second housing part includes a first positioning structure and a second positioning structure, the first positioning structure formed on one side of the second housing part, and the second positioning structure formed on the other side of the second housing part.

In one embodiment, the present disclosure provides a pluggable expansion module suitable for connecting an electronic device, including a plurality of pluggable expansion devices. The adjacent pluggable expansion devices are connected to each other. Each pluggable expansion device includes a device housing and a circuit board. The device housing includes a first connection interface and a second connection interface, and the first connection interface opposite the second connection interface. The circuit board is disposed within the device housing, wherein the circuit board includes a first port corresponding to the first connection interface and suitable for connecting the electronic device.

In one embodiment, each device housing includes two separation bumps, with the separation bumps respectively formed on both sides of each device housing, and the separation bumps of two adjacent pluggable expansion devices abut each other.

In one embodiment, the pluggable expansion module further includes a plurality of lateral locking attachments, wherein each device housing includes a plurality of lateral locking holes, with each lateral locking hole extending in a direction parallel to the width direction of the pluggable expansion device, and each lateral locking attachment connects the lateral locking holes of two adjacent pluggable expansion devices.

In one embodiment, each device housing includes a first positioning structure and a second positioning structure, with the first positioning structure formed on one side of the device housing, and the second positioning structure formed on the other side of the device housing, and one of the first positioning structures of two adjacent pluggable expansion devices connects to the corresponding second positioning structure.

In one embodiment, the present disclosure provides a pluggable expansion device suitable for connecting an electronic device. The pluggable expansion device includes a device housing and a circuit board. The device housing includes a first connection interface, a second connection interface, and a plurality of lateral locking holes, with the first connection interface opposite the second connection interface, and each lateral locking hole extending in a direction parallel to the width direction of the pluggable expansion device, and each lateral locking hole extending through the device housing in the width direction of the pluggable expansion device. The circuit board is disposed within the device housing, wherein the circuit board includes a first port corresponding to the first connection interface and suitable for connecting the electronic device.

The pluggable expansion device of the embodiment of the present disclosure can provide connections of different connection interface specifications in a cascading manner, offering significant innovation in application aspects. Furthermore, the pluggable expansion device embodiment of the present disclosure can also connect electronic devices in a side-by-side manner, greatly enhancing assembly efficiency. Additionally, in some embodiments of the present disclosure, further improvements are provided, such as making it convenient for users to grip, easily checking whether the gold fingers are damaged, reducing collision risks, and so on.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present invention can be more fully understood by reading the subsequent detailed description and examples with references made to the accompanying drawings, wherein:

FIG. 1 is a perspective view showing the pluggable expansion device of the first embodiment of the present disclosure.

FIG. 2 is an exploded view showing the pluggable expansion device of the first embodiment of the present disclosure.

FIG. 3 shows the connection of the pluggable expansion device with the extension expansion device in the first embodiment of the present disclosure.

FIG. 4 shows the pluggable expansion module of the embodiment of the present disclosure.

FIG. 5 shows the pluggable expansion device of the second embodiment of the present disclosure.

FIG. 6 shows the pluggable expansion device of the third embodiment of the present disclosure.

### DETAILED DESCRIPTION OF THE INVENTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

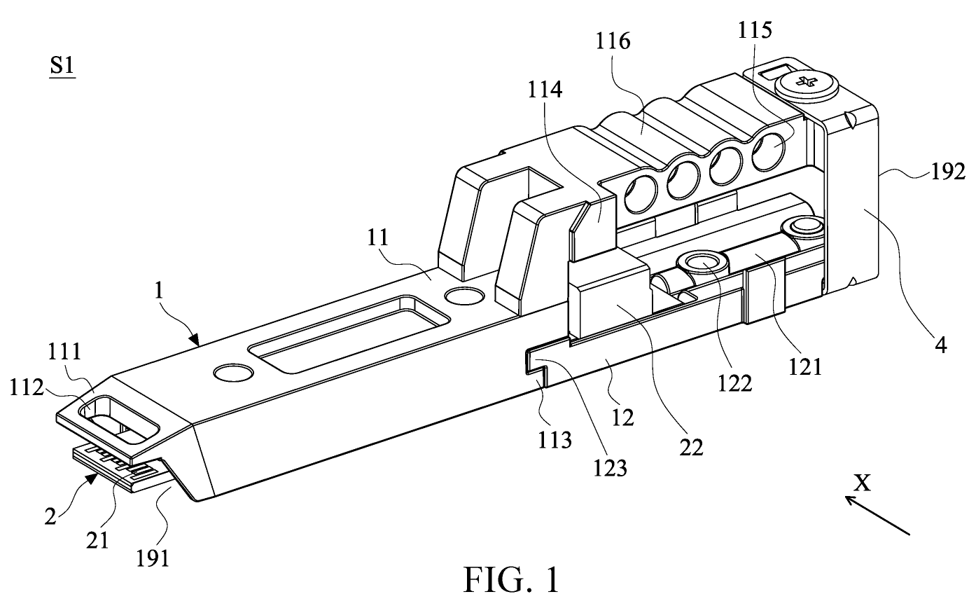

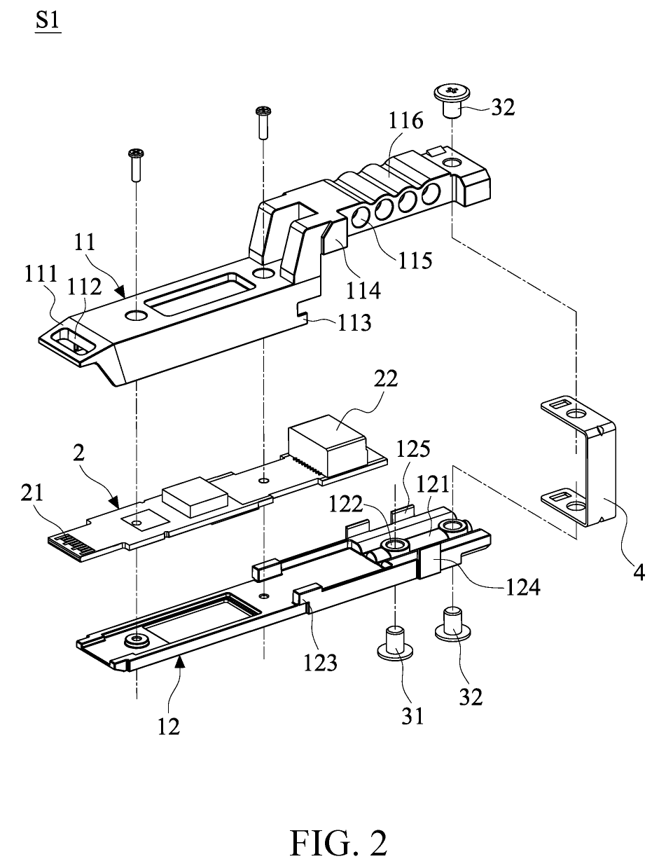

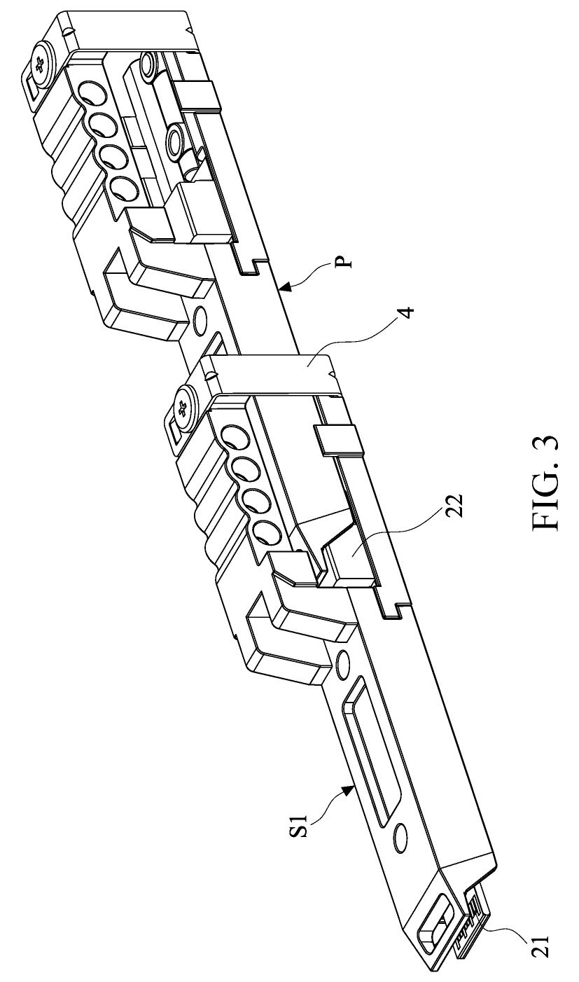

FIG. 1 is a perspective view showing the pluggable expansion device of the first embodiment of the present disclosure. FIG. 2 is an exploded view showing the pluggable expansion device of the first embodiment of the present disclosure. FIG. 3 shows the connection of the pluggable expansion device with the extension expansion device in the first embodiment of the present disclosure. Referring to FIGS. 1, 2, and 3, the pluggable expansion device S1 of the first embodiment of the present disclosure is suitable for connecting an electronic device (not shown) and an extension expansion device P. The pluggable expansion device S1 includes a device housing 1 and a circuit board 2. The device housing 1 includes a first connection interface 191 and a second connection interface 192. The circuit board 2 is disposed within the device housing 1, wherein the circuit board 2 includes a first port 21 and a second port 22, the first port 21 corresponds to the first connection interface 191 and is configured to connect to the electronic device (not shown), and the second port 22 corresponds to the second connection interface 192 and is configured to connect to the extension expansion device P. In other embodiments, the extension expansion device can be a commercially available connector, such as a Small Form-factor Pluggable (SFP) connector, fiber-to-Ethernet connector, etc.

Referring to FIGS. 1, 2, and 3, in one embodiment, the device housing 1 includes a concave-convex structure 121, which is formed in the second connection interface 192 and is suitable for contacting the extension expansion device P. This reduces the friction of the extension expansion device P during the plugging and unplugging process.

Referring to FIGS. 2 and 3, in one embodiment, the pluggable expansion device S1 further includes a fastener 31, wherein the device housing 1 is formed with a through hole 122. When the extension expansion device P is connected to the second port 22, the fastener 31 passes through the through hole 122 and abuts the extension expansion device P. This allows the fastener 31 to provide a limiting effect on the extension expansion device P. In one embodiment, the fastener 31 can be a screw.

Referring to FIG. 2, in one embodiment, the through hole 122 is formed in the concave-convex structure 121. The above disclosure does not limit the present disclosure. In another embodiment, the through hole may also be formed in another suitable location.

Referring to FIGS. 1 and 2, in one embodiment, the device housing includes a first housing part 11 and a second housing part 12, the first housing part 11 is combined with the second housing part 12, and the circuit board 2 is disposed between the first housing part 11 and the second housing part 12.

Referring to FIGS. 1 and 2, in one embodiment, the first housing part 11 includes a first fitting structure 113, and the second housing part 12 includes a second fitting structure 123. The first fitting structure 113 fits with the second fitting structure 123.

Referring to FIGS. 1, 2, and 3, in one embodiment, the pluggable expansion device S1 further includes a sheet metal fastener 4, wherein the sheet metal fastener 4 connects the first housing part 11 and the second housing part 12. In one embodiment, the sheet metal fastener 4 is fixed to the first housing part 11 and the second housing part 12 through locking attachments (such as screws) 32. In one embodiment, the sheet metal fastener 4 is suitable for providing a limiting effect on the extension expansion device P.

Referring to FIGS. 1 and 2, in one embodiment, the first housing part 11 includes a guiding slope 111, which corresponds to the first connection interface 191. The guiding slope 111 can assist the pluggable expansion device S1 in smoothly connecting with the electronic device (not shown) and prevent collisions. In one embodiment, the guiding slope 111 has an angle of inclination in its extending direction, and the sides of the guiding slope 111 may also have guiding edges.

Referring to FIGS. 1 and 2, in one embodiment, a window 112 is formed on the guiding slope 111, corresponding to the first port 21. Through the window 112, users can observe the wear condition of the first port 21.

Referring to FIGS. 1 and 2, in one embodiment, the first housing part 11 includes a separation bump 114, which is formed on at least one side edge of the first housing part 11.

Referring to FIGS. 1 and 2, in one embodiment, the first housing part 11 includes a plurality of lateral locking holes 115, with each lateral locking hole 115 extending in a direction parallel to the width direction X of the pluggable expansion device S1.

Referring to FIGS. 1 and 2, in one embodiment, the first housing part 11 includes an anti-slip structure 116, which is formed on the outer surface of the first housing part 11, thereby facilitating user grip.

Referring to FIGS. 1 and 2, in one embodiment, the second housing part 12 includes a first positioning structure 124 and a second positioning structure 125, with the first positioning structure 124 formed on one side of the second housing part 12, and the second positioning structure 125 formed on the other side of the second housing part 12.

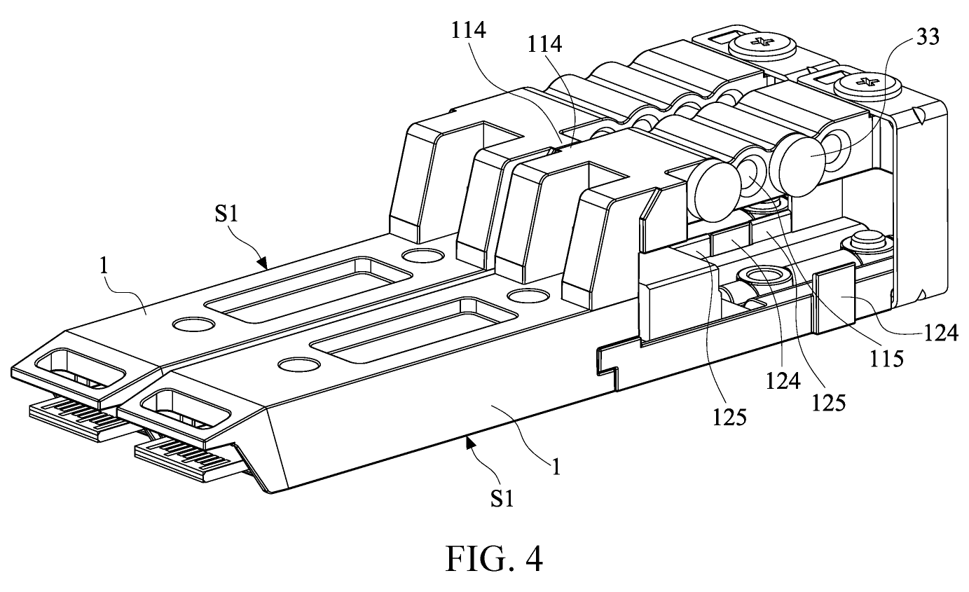

FIG. 4 shows the pluggable expansion module of the embodiment of the present disclosure. Referring to FIG. 4, the pluggable expansion module of the embodiment of the present disclosure includes a plurality of pluggable expansion devices S1, and adjacent pluggable expansion devices S1 connected to each other. Referring to FIGS. 1, 2, and 4, in one embodiment, each device housing 1 includes two separation bumps 114, which are respectively formed on both sides of each device housing 1, and the separation bumps 114 of two adjacent pluggable expansion devices S1 abut each other. In this way, the distances between the pluggable expansion devices S1 can be controlled.

Referring to FIG. 4, in one embodiment, the pluggable expansion module further includes a plurality of lateral locking attachments 33, each lateral locking attachment 33 connecting the lateral locking holes 115 of two adjacent pluggable expansion devices S1.

Referring to FIG. 4, in one embodiment, one of the first positioning structures 124 of two adjacent pluggable expansion devices S1 abuts the corresponding second positioning structure 125. This provides an alignment effect.

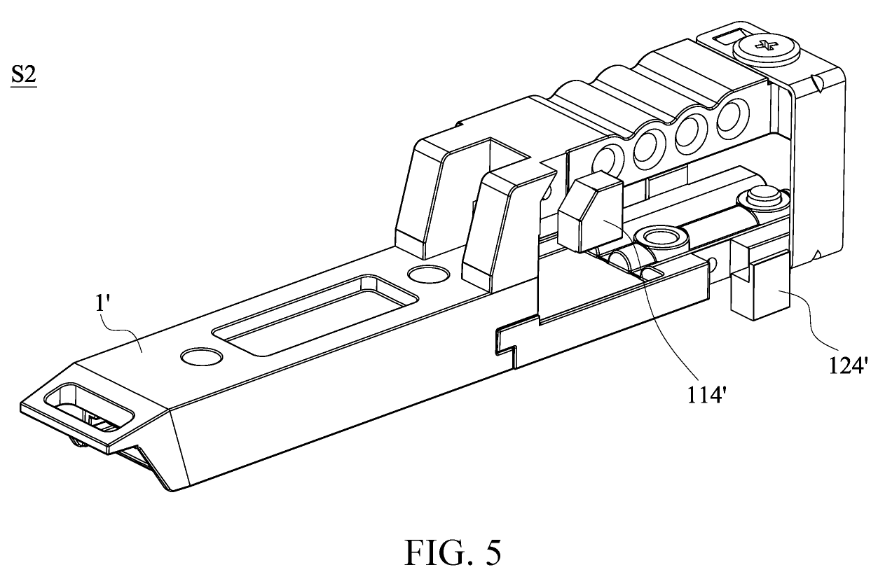

FIG. 5 shows the pluggable expansion device of the second embodiment of the present disclosure. Referring to FIG. 5, in this embodiment, the separation bump 114' of the pluggable expansion device S2 is detachably connected to the device housing 1'. The first positioning structure 124' is also detachably connected to the device housing 1'. This allows adjustment of the spacing between two adjacent pluggable expansion devices S2.

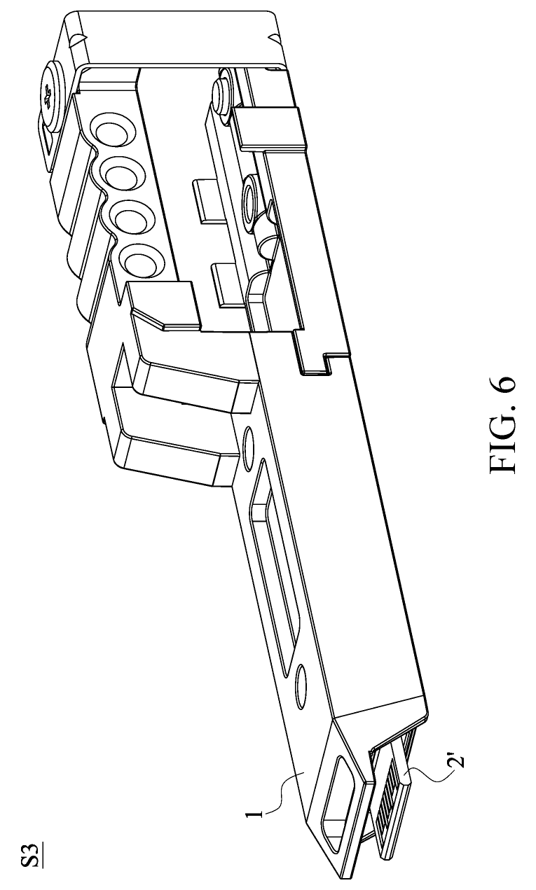

FIG. 6 shows the pluggable expansion device of the third embodiment of the present disclosure. In this embodiment, the pluggable expansion device S3 can be a hot-swappable Small Form-factor Pluggable device. Compared to the previous embodiments, the pluggable expansion device S3 uses a different circuit board 2' to provide different functions.

The pluggable expansion device according to the embodiment of the present disclosure can provide connections of different connection interface specifications in a cascading manner, offering significant innovation in application aspects. Furthermore, the pluggable expansion device embodiment of the present disclosure can also connect electronic devices in a side-by-side manner, greatly enhancing assembly efficiency. Additionally, in some embodiments of the present disclosure, further improvements are provided, such as making it convenient for users to grip, easily checking whether the gold fingers are damaged, reducing collision risks, and so on.

Although the present disclosure has been disclosed above with specific preferred embodiments, it is not intended to limit the present disclosure. A person skilled in the art can still make some modifications and refinements without departing from the spirit and scope of the present disclosure. Therefore, the protection scope of the present disclosure should be defined by the claims below.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pluggable expansion device suitable for connecting an electronic device and an extension expansion device, comprising:
a device housing, including a first connection interface and a second connection interface; and
a circuit board, disposed within the device housing, wherein the circuit board includes a first port and a second port, the first port corresponds to the first connection interface and is configured to connect to the electronic device, and the second port corresponds to the second connection interface and is configured to connect to the extension expansion device.

2. The pluggable expansion device according to claim 1, wherein the device housing includes a concave-convex structure, formed in the second connection interface, suitable for contacting the extension expansion device.

3. The pluggable expansion device according to claim 2, further comprising a fastener, wherein the device housing is formed with a through hole, when the extension expansion device is connected to the second port, the fastener passes through the through hole and abuts the extension expansion device.

4. The pluggable expansion device according to claim 3, wherein the through hole is formed in the concave-convex structure.

5. The pluggable expansion device according to claim 1, wherein the device housing includes a first housing part and a second housing part, the first housing part is combined with the second housing part, and the circuit board is disposed between the first housing part and the second housing part.

6. The pluggable expansion device according to claim 5, wherein the first housing part includes a first fitting structure, and the second housing part includes a second fitting structure, and the first fitting structure fits with the second fitting structure.

7. The pluggable expansion device according to claim 6, further comprising a sheet metal fastener, wherein the sheet metal fastener connects the first housing part and the second housing part.

8. The pluggable expansion device according to claim 7, wherein the first housing part includes a guiding slope, corresponding to the first connection interface.

9. The pluggable expansion device according to claim 8, wherein a window is formed on the guiding slope, corresponding to the first port.

10. The pluggable expansion device according to claim 7, wherein the first housing part includes a separation bump, formed on at least one side edge of the first housing part.

11. The pluggable expansion device according to claim 7, wherein the first housing part includes a plurality of lateral locking holes, each lateral locking hole extending in a direction parallel to the width direction of the pluggable expansion device.

12. The pluggable expansion device according to claim 7, wherein the first housing part includes an anti-slip structure, formed on an outer surface of the first housing part.

13. The pluggable expansion device according to claim 7, wherein the second housing part includes a first positioning structure and a second positioning structure, with the first positioning structure formed on one side of the second housing part, and the second positioning structure formed on the other side of the second housing part.

14. A pluggable expansion module suitable for connecting an electronic device, comprising:
a plurality of pluggable expansion devices, wherein adjacent pluggable expansion devices are connected to each other, each pluggable expansion device comprising:
a device housing, including a first connection interface and a second connection interface, the first connection interface opposite the second connection interface; and
a circuit board, disposed within the device housing, wherein the circuit board includes a first port, the first port corresponds to the first connection interface and is configured to connect to the electronic device.

15. The pluggable expansion module according to claim 14, wherein each device housing includes two separation bumps, which are respectively formed on both sides of each device housing, and the separation bumps of two adjacent pluggable expansion devices abut each other.

16. The pluggable expansion module according to claim 14, further comprising a plurality of lateral locking attachments, wherein each device housing includes a plurality of lateral locking holes, each lateral locking hole extending in a direction parallel to the width direction of the pluggable expansion device, and each lateral locking attachment connects the lateral locking holes of two adjacent pluggable expansion devices.

17. The pluggable expansion module according to claim 14, wherein each device housing includes a first positioning structure and a second positioning structure, the first positioning structure formed on one side of the device housing, and the second positioning structure formed on the other side of the device housing, and one of the first positioning structures of two adjacent pluggable expansion devices connects to the corresponding second positioning structure.

18. The pluggable expansion module according to claim 14, wherein each device housing includes a concave-convex structure, formed in the second connection interface.

19. The pluggable expansion module according to claim 18, further comprising a plurality of fasteners, wherein each device housing is formed with a through hole, and the fastener is suitable for passing through the through hole.

20. A pluggable expansion device suitable for connecting an electronic device, comprising:
a device housing, including a first connection interface, a second connection interface, and a plurality of lateral locking holes, the first connection interface opposite the second connection interface, and each lateral locking hole extending in a direction parallel to the width direction of the pluggable expansion device, and each lateral locking hole extending through the device housing in the width direction of the pluggable expansion device; and
a circuit board, disposed within the device housing, wherein the circuit board includes a first port, the first port corresponds to the first connection interface and is configured to connect to the electronic device.
